(19) United States
(12) Patent Application Publication
(10) Pub. No.: US 2012/0013434 A1
(43) Pub. Date: Jan. 19, 2012

(54) WIRELESS SENSING MODULE, WIRELESS LIGHTING CONTROLLING APPARATUS AND WIRELESS LIGHTING SYSTEM

(75) Inventors: Jung Hwan PARK, Busan (KR); Sang Kyeong YUN, Suwon-si (KR); Chang Seob KIM, Seoul (KR); Ho Chan CHO, Suwon-si (KR); Heui Sam KWAG, Suwon-si (KR)

(73) Assignee: SAMSUNG LED CO., LTD., Suwon-si (KR)

(21) Appl. No.: 13/185,804

(22) Filed: Jul. 19, 2011

(30) Foreign Application Priority Data
Jul. 19, 2010 (KR) 10-2010-0069501

(51) Int. Cl. G05B 23/02

(52) U.S. Cl. 340/3.1

(57) ABSTRACT

Provided is a wireless sensing module, a wireless lighting controlling apparatus, and a wireless lighting system. The wireless sensing module may include a motion sensor to sense a motion, an illumination intensity sensor to sense an intensity of illumination, and a first wireless communication unit to generate and transmit a wireless signal that includes a motion sensing signal and an illumination intensity sensing signal, and that complies with a predetermined communication regulation. The wireless lighting controlling apparatus may include a second wireless communication unit to receive a wireless signal from a first wireless communication unit, and to restore a sensing signal, a sensing signal analyzing unit to analyze the sensing signal, and an operation controller to perform a predetermined control based on a result of the analysis. The wireless lighting system may include the wireless sensing module and the wireless lighting controlling apparatus.

### CROSS-REFERENCE TO RELATED APPLICATION

This application claims the priority benefit of Korean Patent Application No. 10-2010-0069501, filed on Jul. 19, 2010, in the Korean Intellectual Property Office, the disclosure of which is incorporated herein by reference.

### BACKGROUND

1. Field

Example embodiments relate to a wireless lighting system that may be applicable to a lighting controlling system used in homes, offices, and the like. In particular, example embodiments relate to a wireless sensing module, a wireless lighting controlling apparatus and a wireless lighting controlling system that may detect a motion and an intensity of illumination at a target location, may wirelessly transmit and receive information obtained from the detection through a wireless communication, such as a ZigBee communication scheme and the like, and may automatically perform a predetermined control based on the detected motion and intensity of illumination.

2. Description of the Related Art

In general, when a conventional lighting device is in use, users determine brightness at a place where a ramp for illumination is installed, and may turn the lamp on and off based on the brightness. However, since users should manually manipulate the lamp, a scope of application is limited.

The lighting device for the front door may sense people coming and going, and may automatically turn the lamp on and off.

Conventionally, the lighting device for the front door including a motion sensor is installed only at the front door, may not obtain information associated with an event occurring at the front door, that is, information associated with accesses to the front door, and may limit an application field when the lighting device is singly utilized.

Also, the lighting device including an illumination intensity sensor may detect an intensity of illumination to adjust the brightness of illumination, and may limit an application field when the lighting device is singly utilized, like the lighting device for the front door.

### SUMMARY

An aspect of example embodiments may provide a wireless sensing module, a wireless lighting controlling apparatus, and a wireless lighting system that may detect a motion and an intensity of illumination at a target location that is monitored, may wirelessly transmit and receive the detected information through wireless communication, such as a ZigBee communication scheme and the like, and may automatically perform a predetermined control based on the detected motion and intensity of illumination at the target location.

The foregoing and/or other aspects are achieved by providing a wireless sensing module, including a motion sensor to sense a motion, an illumination intensity sensor to sense an intensity of illumination, and a first wireless communication unit to generate and transmit a wireless signal that includes a motion sensing signal from the motion sensor and an illumination intensity sensing signal from the illumination intensity sensor, and that complies with a predetermined communication regulation.

The foregoing and/or other aspects are achieved by providing a wireless lighting controlling apparatus that performs wireless communication with a wireless sensing module, the apparatus including a second wireless communication unit to receive a wireless signal from a first wireless communication unit, and to restore a sensing signal, a sensing signal analyzing unit to analyze the sensing signal from the second wireless communication unit, and an operation controller to perform a predetermined control based on a result of the analysis in the sensing signal analyzing unit, and the wireless sensing module includes a motion sensor to sense a motion, an illumination intensity sensor to sense an intensity of illumination, and the first wireless communication unit to generate and transmit the wireless signal that includes a motion sensing signal from the motion sensor and an illumination intensity sensing signal from the illumination intensity sensor, and that complies with a predetermined communication regulation.

The foregoing and/or other aspects are achieved by providing a wireless lighting system, the system including a wireless sensing module and a wireless lighting controlling apparatus, the wireless sensing module including a motion sensor to sense a motion, an illumination intensity sensor to sense an intensity of illumination, and a first wireless communication unit to generate and transmit a wireless signal that includes a motion sensing signal from the motion sensor and an illumination intensity sensing signal from the illumination intensity sensor, and that complies with a predetermined communication regulation, and the wireless lighting controlling apparatus including a second wireless communication unit to receive the wireless signal from the first wireless communication unit, and to restore a sensing signal, and a sensing signal analyzing unit to analyze the sensing signal from the second wireless communication unit, and an operation controller to perform a predetermined control based on the sensing signal analyzing unit.

The motion sensor may include a human body sensor that senses a human body.

The first wireless communication unit may correspond to a first ZigBee communication unit that generates and transmits a ZigBee signal complying with a predetermined ZigBee communication regulation, and the second wireless communication unit may receive the ZigBee signal from the first ZigBee communication unit, and may restore a sensing signal.

The ZigBee signal of the first ZigBee communication unit may include channel information associated with a communication channel, wireless network identification information associated with a wireless network, a device address designating a target device, and sensing signal including the motion sensing signal and the illumination intensity sensing signal.

The ZigBee signal of the second ZigBee communication unit may include channel information associated with a communication channel, wireless network identification information associated with a wireless network, a device address designating a target device, and sensing signal including the motion sensing signal and the illumination intensity sensing signal.

The sensing signal analyzing unit may analyze the sensing signal from the second ZigBee communication unit to detect, based on the sensed motion and the sensed intensity of illumination, a condition among a plurality of predetermined conditions.

The operation controller may set a plurality of controls corresponding to a plurality of predetermined conditions determined, in advance, in the sensing signal analyzing unit, and may perform a control corresponding to a condition detected by the sensing signal analyzing unit.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram illustrating a wireless sensing module, a wireless lighting controlling apparatus, and a wireless lighting system according to example embodiments;

FIG. 2 is a diagram illustrating a format of a ZigBee signal;

FIG. 3 is a diagram illustrating a sensing signal analyzing unit and an operation controller; and

FIG. 4 is a flowchart illustrating a wireless lighting system.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

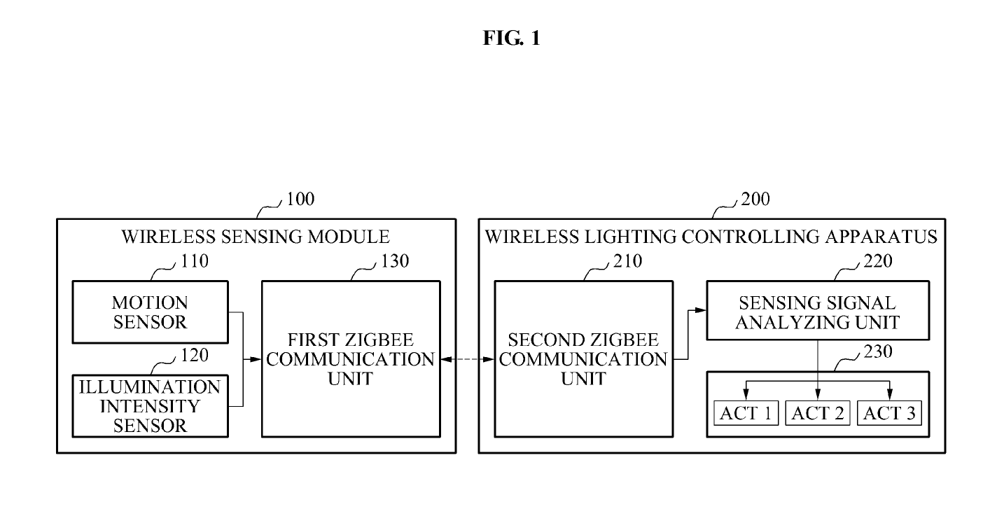

FIG. 1 illustrates a wireless sensing module 100, a wireless lighting controlling apparatus 200, and a wireless lighting system according to example embodiments.

Referring to FIG. 1, the wireless sensing module 100 includes a motion sensor 110, an illumination intensity sensor 120, and a first wireless communication unit. The motion sensor 110 may sense a motion, the illumination intensity sensor 120 may sense an intensity of illumination, and the first wireless communication unit may generate and transmit a wireless signal that includes a motion sensing signal from the motion sensor and an illumination intensity sensing signal from the illumination intensity sensor and that complies with a predetermined communication regulation.

The wireless lighting controlling apparatus 200 includes a second wireless communication unit, a sensing signal analyzing unit 220, and an operation controller 230. The second wireless communication unit may receive the wireless signal from the first wireless communication unit, and may restore a sensing signal, the sensing signal analyzing unit 220 analyzes the sensing signal from the second wireless communication unit, and the operation controller 230 may perform a predetermined control based on a result of the analysis of the sensing signal analyzing unit 220.

The wireless lighting system includes the wireless sensing module 100 and the wireless lighting controlling apparatus 200.

The first wireless communication unit may correspond to a first ZigBee communication unit 130 that generates and transmits a ZigBee signal complying with a predetermined ZigBee a communication regulation, and the second wireless communication unit may correspond to a second ZigBee communication unit 210 that receives the ZigBee signal from the first ZigBee communication unit, and restores a sensing signal. Example embodiments will be described based on a case in which the first ZigBee communication unit 130 and the second ZigBee communication unit 210 are used as the first wireless communication unit and the second wireless communication unit respectively.

The motion sensor 110 may include a human body sensor that may sense a human body, such as an infrared light sensor that senses a motion of a human.

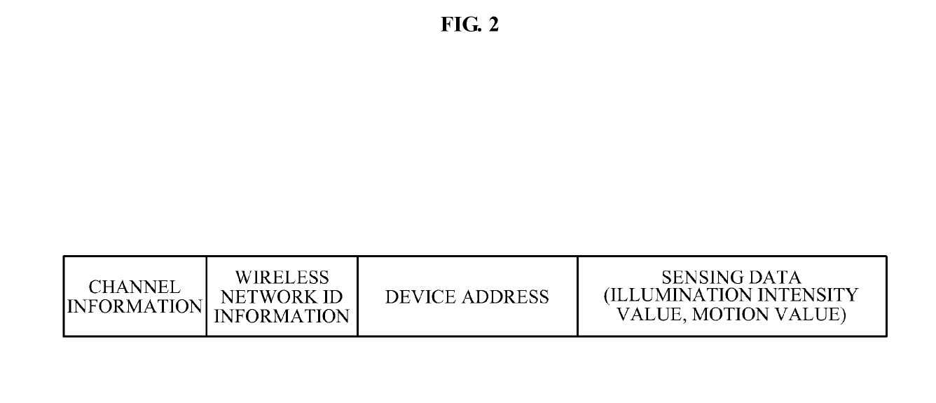

FIG. 2 illustrates a format of a ZigBee signal.

Referring to FIG. 2, a ZigBee signal of the first ZigBee communication unit 130 may include channel information associated with a communication channel, wireless network identification information (PAN_ID) associated with a wireless network, a device address designating a target device, and sensing signal including a motion sensing signal and an illumination intensity sensing signal.

A ZigBee signal of the second ZigBee communication unit 210 may include channel information associated with a communication channel, wireless network identification information (PAN_ID) associated with a wireless network, a device address designating a target device, and sensing signal including a motion sensing signal and an illumination intensity sensing signal.

The sensing signal analyzing unit 220 may analyze a sensing signal from the second ZigBee communication unit 210, and may detect, based on a sensed motion and a sensed intensity of illumination, a condition among a plurality of predetermined conditions.

In this example, the operation controller 230 may set a plurality of controls based on the predetermined conditions that are determined in advance in the sensing signal analyzing unit 220, and may perform a control corresponding to the condition detected by the sensing signal analyzing unit 220.

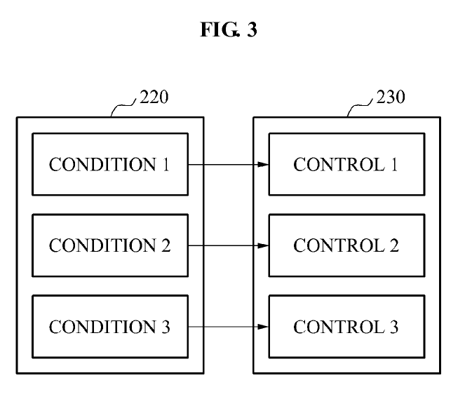

FIG. 3 illustrates the sensing signal analyzing unit 220 and the operation controller 230. For example, the sensing signal analyzing unit 220 may analyze a sensing signal from the second ZigBee communication unit 210, and may detect a condition satisfying a sensed motion and a sensed illumination, from among a first condition (condition 1), a second condition (condition 2), and a third condition (condition 3).

In this example, the operation controller 230 may set a first control (control 1), a second control (control 2), and a third control (control 3) corresponding to the predetermined condition 1, condition 2, and condition 3, respectively, and may perform a control corresponding to the condition detected by the sensing signal analyzing unit 220.

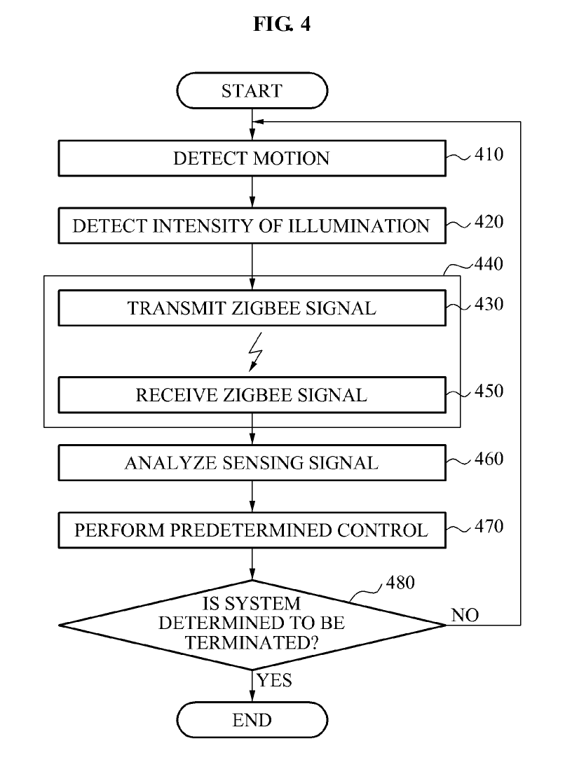

FIG. 4 illustrates operations of a wireless lighting system.

In operation 410, the motion sensor 110 may detect a motion.

In operation 420, the illumination intensity sensor 120 may detect an intensity of illumination. Operation 440 is a process for transmitting and receiving a ZigBee signal. Operation 440 may include operation 430 in which the first ZigBee communication unit 130 transmits a ZigBee signal, and operation 450 in which the second ZigBee communication unit 210 receives the ZigBee signal. In operation 460, the sensing signal analyzing unit 220 analyzes a sensing signal. In operation 470, the operation controller 230 performs a predetermined control. In operation 480, the wireless lighting system determines whether to terminate the wireless lighting system.

Effects of example embodiments will be described based on the accompanying drawings.

The wireless sensing module 100, the wireless lighting controlling apparatus 200, and the wireless lighting system will be described with reference to FIGS. 1 through 4.

Referring to FIGS. 1, 2, and 4, the wireless sensing module 100 is installed in a place where a lighting device is installed, and may detect an intensity of illumination of the lighting device and may detect a motion of a human near the lighting device.

The motion sensor 110 of the wireless sensing module 100 may include an infrared sensor and the like that senses a human, may sense a motion, and may provide the sensed motion to the first ZigBee communication unit 130 in operation 410. The intensity illumination sensor 120 of the wireless sensing module 100 may sense an intensity of illumination and may provide the sensed intensity to the first ZigBee communication unit 130 in operation 420.

Accordingly, the first ZigBee communication unit 130 may generate and transmit a ZigBee signal that includes a motion sensing signal from the motion sensor 110 and an illumination intensity sensing signal from the intensity illumination sensor 120, and that complies with a predetermined communication regulation in operation 430.

Referring to FIG. 2, the ZigBee signal of the first ZigBee communication unit 130 may include channel information associated with a communication channel, PAN_ID associated with a wireless network, a device address designating a target device, and sensing signal including a motion value and an illumination intensity value.

Referring to FIGS. 1 through 4, the wireless lighting controlling apparatus 200 may control a predetermined operation, based on the illumination intensity value and the motion value included in the ZigBee signal from the wireless sensing module 100.

The second ZigBee communication unit 210 in the wireless lighting controlling apparatus 200 may receive the ZigBee signal from the first ZigBee communication unit 130, may restore a sensing signal from the received ZigBee signal, and may provide the sensing signal to the sensing signal analyzing unit 220 in operation 450.

Referring to FIG. 2, a ZigBee signal of the second ZigBee communication unit 210 may include channel information associated with a communication channel, PAN_ID associated with a wireless network, a device address designating a target device, and sensing data. The wireless lighting system may identify a wireless network based on PAN_ID, and may identify a sensed device based on the device address. The sensing signal may include a motion value and an illumination intensity value.

Referring to FIG. 1, the sensing signal analyzing unit 220 may analyze the illumination intensity value and the motion value included in the sensing signal received from the second ZigBee communication unit 210, and may provide a result of the analysis to the operation controller 230 in operation 460.

Accordingly, the operation controller 230 may perform a predetermined control based on the result of the analysis of the sensing signal analyzing unit 220 in operation 470.

The sensing signal analyzing unit 220 may analyze the sensing signal received from the second ZigBee communication unit 210, and may detect, based on the sensed motion and the sensed intensity of illumination, a condition among a plurality of predetermined conditions.

The operation controller 230 may set a plurality of controls corresponding to the plurality of predetermined conditions that are determined in advance in the sensing signal analyzing unit 220, and may perform a control corresponding to the condition detected by the sensing signal analyzing unit 220.

Referring to FIG. 3, the sensing signal analyzing unit 220 may analyze the sensing signal received from the second ZigBee communication unit 210, and may detect, based on the sensed motion and the sensed intensity of illumination, a condition among condition 1, condition 2, and condition 3.

In this example, the operation controller 230 may set control 1, control 2, and control 3 corresponding to condition 1, condition 2, and condition 3, respectively, that are determined in advance in the sensing signal analyzing unit 220, and may perform a control corresponding to the condition detected by the sensing signal analyzing unit 220.

For example, when condition 1 corresponds to a case in which a motion is sensed at a front door, and an intensity of illumination at the front door is not dark, control 1 may turn all predetermined lamps off. When condition 2 corresponds to a case in which a motion is sensed at the front door, and the intensity of illumination at the front door is dim, control 1 may turn on a few of the predetermined lamps including lamps at the front door and lamps in a living room. When condition 3 corresponds to a case in which a motion is sensed at the front door, and the intensity of illumination at the front door is dark, control 1 may turn all the predetermined lamps on.

A previous setting may determine control 1, control 2, and control 3 to control various operations in addition to an operation of turning a lamp on and off. For example, control 1, control 2, and control 3 may be associated with an operation of a lamp and an air-conditioner in summer or may be associated with an operation of a lamp and a heater in winter.

As described in the foregoing, the wireless lighting system is installed in a place where a lamp is installed or a place where people come and go, to wirelessly control a predetermined operation based on a motion and an intensity of illumination.

According to example embodiment, the wireless lighting system may detect a motion and an intensity of illumination at a target location that is monitored, may wirelessly transmit and receive the detected information through wireless communication, such as a ZigBee communication scheme and the like, and may automatically perform a predetermined control based on the motion and the intensity of illumination.

According to example embodiments, the wireless lighting system may operate in conjunction with a wireless lighting controlling apparatus corresponding to a main system to effectively control an indoor lighting device, and may be configured at a low cost using a ZigBee communication scheme when compared to a conventional system interoperation scheme, such as a wired communication scheme or another wireless communication scheme. Also, the wireless lighting system may interoperate with a sensor to control a lighting device and thus, may effectively perform controlling and may reduce power consumption.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A wireless sensing module, comprising:
a motion sensor to sense a motion;
an illumination intensity sensor to sense an intensity of illumination; and
a first wireless communication unit to generate and transmit a wireless signal that includes a motion sensing signal from the motion sensor and an illumination intensity sensing signal from the illumination intensity sensor, and that complies with a predetermined communication regulation.

2. The wireless sensing module of claim 1, wherein the first wireless communication unit corresponds to a first ZigBee communication unit that generates and transmits a ZigBee signal complying with a predetermined ZigBee communication regulation.

3. The wireless sensing module of claim 2, wherein the motion sensor comprises a human body sensor that senses a human body.

4. The wireless sensing module of claim 2, wherein the ZigBee signal of the first ZigBee communication unit comprises:
channel information associated with a communication channel, wireless network identification information associated with a wireless network, a device address designating a target device, and sensing signal including the motion sensing signal and the illumination intensity sensing signal.

5. A wireless lighting controlling apparatus that performs wireless communication with a wireless sensing module, the apparatus comprising:
a second wireless communication unit to receive a wireless signal from a first wireless communication unit, and to restore a sensing signal;
a sensing signal analyzing unit to analyze the sensing signal from the second wireless communication unit; and
an operation controller to perform a predetermined control based on a result of the analysis in the sensing signal analyzing unit,
wherein the wireless sensing module comprises:
a motion sensor to sense a motion;
an illumination intensity sensor to sense an intensity of illumination; and
the first wireless communication unit to generate and transmit the wireless signal that includes a motion sensing signal from the motion sensor and an illumination intensity sensing signal from the illumination intensity sensor, and that complies with a predetermined communication regulation.

6. The apparatus of claim 5, wherein:
the first wireless communication unit corresponds to a first ZigBee communication unit that generates and transmits a ZigBee signal complying with a predetermined ZigBee communication regulation; and
the second wireless communication unit receives the ZigBee signal from the first ZigBee communication unit, and restores a sensing signal.

7. The apparatus of claim 6, wherein the ZigBee signal of the second ZigBee communication unit comprises channel information associated with a communication channel, wireless network identification information associated with a wireless network, a device address designating a target device, and sensing signal including the motion sensing signal and the illumination intensity sensing signal.

8. The apparatus of claim 6, wherein the sensing signal analyzing unit analyzes the sensing signal from the second ZigBee communication unit to detect, based on the sensed motion and the sensed intensity of illumination, a condition among a plurality of predetermined conditions.

9. The apparatus of claim 7, wherein the operation controller sets a plurality of controls corresponding to a plurality of predetermined conditions determined, in advance, in the sensing signal analyzing unit, and performs a control corresponding to a condition detected by the sensing signal analyzing unit.

10. A wireless lighting system, the system comprising:
a wireless sensing module comprising a motion sensor to sense a motion, an illumination intensity sensor to sense an intensity of illumination, and a first wireless communication unit to generate and transmit a wireless signal that includes a motion sensing signal from the motion sensor and an illumination intensity sensing signal from the illumination intensity sensor, and that complies with a predetermined communication regulation; and
a wireless lighting controlling apparatus comprising a second wireless communication unit to receive the wireless signal from the first wireless communication unit, and to restore a sensing signal, and a sensing signal analyzing unit to analyze the sensing signal from the second wireless communication unit, and an operation controller to perform a predetermined control based on the sensing signal analyzing unit.

11. The system of claim 10, wherein:
the first wireless communication unit corresponds to a first ZigBee communication unit that generates and transmits a ZigBee signal complying with a predetermined ZigBee communication regulation; and
the second wireless communication unit receives the ZigBee signal from the first ZigBee communication unit, and restores a sensing signal.

12. The system of claim 11, wherein the motion sensor comprises a human body sensor to sense a human body.

13. The system of claim 11, wherein the ZigBee signal of the first ZigBee communication unit comprises channel information associated with a communication channel, wireless network identification information associated with a wireless network, a device address designating a target device, and sensing signal including the motion sensing signal and the illumination intensity sensing signal.

14. The system of claim 11, wherein the ZigBee signal of the second ZigBee communication unit comprises channel information associated with a communication channel, wireless network identification information associated with a wireless network, a device address designating a target device, and sensing signal including the motion sensing signal and the illumination intensity sensing signal.

15. The system of claim 11, wherein the sensing signal analyzing unit analyzes the sensing signal from the second ZigBee communication unit to detect, based on the sensed motion and the sensed intensity of illumination, a condition among a plurality of predetermined conditions.

16. The system of claim 15, wherein the operation controller sets a plurality of controls corresponding to a plurality of predetermined conditions determined, in advance, in the sensing signal analyzing unit, and performs a control corresponding to the condition detected by the sensing signal analyzing unit.
